(19) United States
(12) Patent Application Publication
(10) Pub. No.: US 2017/0094029 A1
(43) Pub. Date: Mar. 30, 2017

(54) APPARATUS TO CONTROL DATA DISTRIBUTION TO COMMUNICATION DEVICES DEPENDING ON TYPES OF DATA

(71) Applicant: FUJITSU LIMITED, Kawasaki-shi (JP)

(72) Inventor: Junichi YOSHIMURA, Kawasaki (JP)

(73) Assignee: FUJITSU LIMITED, Kawasaki-shi (JP)

(21) Appl. No.: 15/252,927

(22) Filed: Aug. 31, 2016

(30) Foreign Application Priority Data
Sep. 30, 2015 (JP) 2015-195092

(51) Int. Cl. H04L 29/06; H04L 29/08

(52) U.S. Cl. CPC H04L 67/42; H04L 67/327

(57) ABSTRACT

An apparatus stores first information in which a type of data held in each of a plurality of communication devices to be monitored and controlled is stored in association with the each communication device. When a first communication device that uses data of a first type is added to the plurality of communication devices, the apparatus searches the first information for a second communication device that holds data whose type is the first type, and instructs the second communication device to transfer data held by the second communication device to the first communication device.

### CROSS-REFERENCE TO RELATED APPLICATION

This application is based upon and claims the benefit of priority of the prior Japanese Patent Application No. 2015-195092, filed on Sep. 30, 2015, the entire contents of which are incorporated herein by reference.

### FIELD

The embodiment discussed herein is related to apparatus to control data distribution to communication devices depending on types of data.

### BACKGROUND

For example, communication devices of many types are used based on network applications for various environments such as residential, business, and mobile environments. The communication devices include variations in function and performance based on the network applications.

As an example, a communication device is composed of communication units for executing a communication process, a monitoring and controlling unit for monitoring and controlling the communication units, shelves for accommodating the communication units and the monitoring and controlling unit, a rack to which the shelves are attached, and the like. In each of the communication units, a field programmable gate array (FPGA), a central processing unit (CPU), and the like are installed in order to achieve the desired communication process. The FPGAs and the CPUs operate in accordance with software (or firmware data on the CPUs, circuit data on the FPGAs, and the like) held in the communication units.

The software data may be stored in nonvolatile memories included in the communication units or the like at the time of manufacturing the communication units. The software data, however, may be downloaded from the monitoring and controlling unit to the communication units (refer to, for example, Japanese Laid-open Patent Publication NO. 2007-323399).

### SUMMARY

According to an aspect of the invention, an apparatus stores first information in which a type of data held in each of a plurality of communication devices to be monitored and controlled is stored in association with the each communication device. When a first communication device that uses data of a first type is added to the plurality of communication devices, the apparatus searches the first information for a second communication device that holds data whose type is identical to the first type, and instructs the second communication device to transfer data held by the second communication device to the first communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a monitoring and controlling system, according to an embodiment;

FIG. 2 is a diagram illustrating an example of a physical arrangement of communication units, according to an embodiment;

FIG. 3 is a diagram illustrating an example of a configuration of a communication unit, according to an embodiment;

FIG. 4 is a diagram illustrating an example of a configuration of a monitoring and controlling unit, according to an embodiment;

FIG. 5A is a diagram illustrating an example of download statistics information indicating the numbers of communication units for types of software data, according to an embodiment;

FIG. 5B is a diagram illustrating an example of download statistics information indicating frequencies at which software data is downloaded for types of software data, according to an embodiment;

FIG. 5C is a diagram illustrating an example of download statistics information indicating sizes of software data for types of software data, according to an embodiment;

FIG. 6 is a diagram illustrating an example of a configuration of a network managing device, according to an embodiment;

FIG. 7 is a diagram illustrating an example of operations for transferring software data upon activation of a monitoring and controlling system, according to an embodiment;

FIG. 8 is a diagram illustrating an example of an operational flowchart for a process to be executed by each of communication units upon activation, according to an embodiment;

FIG. 9 is a diagram illustrating an example of an operational flowchart for a process to be executed by each of monitoring and controlling units upon activation, according to an embodiment;

FIG. 10 is a diagram illustrating an example of an operation for transferring software data between communication units, according to an embodiment;

FIG. 11 is a diagram illustrating an example of an operational sequence for a process to be executed by monitoring and controlling system in a case where software data is transferred between communication units, according to an embodiment;

FIG. 12 is a diagram illustrating an example of an operational flowchart for a process to be executed by a communication unit upon reception of an instruction to transfer software data, according to an embodiment;

FIG. 13 is a diagram illustrating an example of an operation for transferring reserve software data from a monitoring and controlling unit to a communication unit, according to an embodiment;

FIG. 14 is a diagram illustrating an example of an operational sequence for a process to be executed by a monitoring and controlling system in a case where reserve software data is transferred from a monitoring and controlling unit to a communication unit, according to an embodiment;

FIG. 15 is a diagram illustrating an example of operations for transferring software data from a network managing device to a new communication unit, according to an embodiment;

FIG. 16 is a diagram illustrating an example of an operational sequence for a process to be executed by a monitoring and controlling system in a case where software data is transferred from a network managing device to a new communication unit, according to an embodiment; and

FIG. 17 is a diagram illustrating an example of an operational flowchart for a process to be executed by each of monitoring and controlling units after activation of a monitoring and controlling system, according to an embodiment.

### DESCRIPTION OF EMBODIMENT

In order to form an integrated network system that does not depend on a network application, new communication units that flexibly achieve various functions and various performance levels by a common main hardware configuration have been researched and developed. The communication units are of one type, and each of the communication units may achieve different functions and different performance levels by the replacement of detachable small form-factor pluggable (SFP) that is a transceiver module for transmitting and receiving main signals, and the downloading of software data, for example.

Thus, for example, a single communication unit may operate as a “100G Ethernet” (registered trademark, hereinafter the same applies in this specification) communication device or operate as a “10G-passive optical network (PON)” communication device or a “common public radio interface (CPRI)” communication device. It is, therefore, possible to support various network applications by combining multiple communication units regardless of installation locations, configuring the communication units in a non-physical or virtual shelf (hereinafter referred to as virtual shelf), and managing the communication units.

Even if the virtual shelf is used, a monitoring and controlling unit is used. The monitoring and controlling unit serves as an independent device and monitors and controls communication units within one or more virtual shelves, since such physical shelves as described above do not exist.

When a physical shelf is used, the monitoring and controlling unit downloads software data to communication units. Accordingly, holding only data based on the types of the communication units accommodated in the same physical shelf as the monitoring and controlling unit is sufficient for the monitoring and controlling unit.

However, when the virtual shelf is used, the monitoring and controlling unit is required to hold data of many types based on all functions and performance levels that are achieved by the communication units. Thus, a large-capacity storage device for storing the data of all the types is required to be installed in the monitoring and controlling unit, thereby increasing the cost and size of the monitoring and controlling unit.

It is preferable to provide a monitoring and controlling device in which a memory capacity for storing software data is reduced, and to provide a monitoring and controlling system in which a memory capacity for storing software data is reduced.

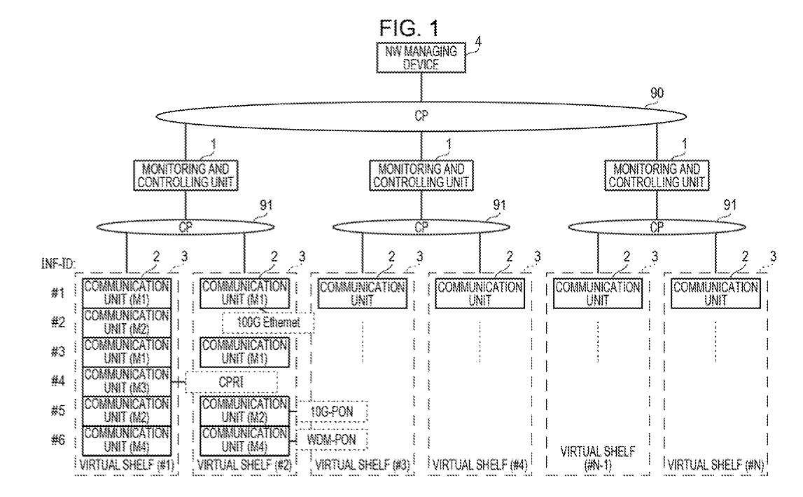

FIG. 1 is a configuration diagram illustrating an example of a monitoring and controlling system. The monitoring and controlling system includes multiple monitoring and controlling units 1, multiple communication units 2, and a network (NW) managing device 4. The NW managing device 4 communicates with the monitoring and controlling units 1 via a control plane (CP) 90. The monitoring and controlling units 1 communicate via CPs 91 with the communication units 2 to be monitored and controlled. The CPs 90 and 91 are, for example, high-security dedicated networks such as virtual private networks (VPNs), but are not limited to this.

The NW managing device 4 is a server having a network operating system (OpS) installed therein. The NW managing device 4 manages the overall networks. The NW managing device 4 has, stored therein, software data that is used for the communication units 2, as described later. The software data is an example of data.

Each of the monitoring and controlling units 1 is an example of a monitoring and controlling device, and monitors and controls multiple communication units 2. The NW managing device 4 manages, for each of virtual shelves 3, communication units 2 to be monitored and controlled, where the virtual shelves 3 are different from physical shelves.

Shelf IDs (#1, #2, . . . , #M (M is a positive integer)) that are identifiers are assigned to the virtual shelves 3, respectively, while one or more communication units 2 belong to each of the virtual shelves 3. In each of the communication units 2, a shelf ID of a shelf to which the communication unit 2 belongs is set upon activation. In an embodiment, each of the monitoring and controlling units 1 manages communication units 2 belonging to two virtual shelves 3. The number of virtual shelves 3 to be managed by each of the monitoring and controlling units 1, however, is not limited.

Each of the monitoring and controlling units 1 acquires software data from the NW managing device 4 upon the activation (initial configuration) of the monitoring and controlling system, and downloads (transfers) the software data to all communication units 2 belonging to virtual shelves 3 to be monitored and controlled by the monitoring and controlling unit 1. In addition, when a new communication unit 2 is added to a virtual shelf 3 to be monitored and controlled by a monitoring and controlling unit 1, the monitoring and controlling unit 1 selects one of three transfer processes, and transfers software data to the new communication unit 2, as will be described later.

Each of the communication units 2 is an example of a communication device, and executes a communication process for a subscriber who subscribes for a communication service, for example. Each of the communication units 2 flexibly achieves various functions and various performance levels by a common main hardware configuration. The communication units 2 are of one type. For example, each of the communication units 2 may achieve different functions and different performance levels by the replacement of detachable SFP, the downloading of software data, and the like, as will be described later.

Thus, the communication units 2 may form an integrated network system that does not depend on a network application. In the following description, functions and performance levels of each of the communication units 2 are referred to as “modes” (“M1”, “M2”, . . . ) of the communication unit 2.

In the embodiment, two communication units 2 in the mode M1, two communication units 2 in the mode M2, one communication unit 2 in a mode M3, and one communication unit 2 in a mode M4 belong to a virtual shelf (#1) 3, for example. In the embodiment, two communication units 2 in the mode M1, one communication unit 2 in the mode M2, and one communication unit 2 in the mode M4 belong to a virtual shelf (#2) 3, for example.

As an example, communication units 2 in the mode M1 operate as “100G Ethernet” communication devices, and communication units 2 in the mode M2 operate as “10G-PON” communication devices. In addition, a communication unit 2 in the mode M3 operates as a “CPRI” communication device, and a communication unit 2 in the mode M4 operates as a “Wavelength Division Multiplex (WDM)-PON” communication device.

In this manner, various network applications may be supported by combining the multiple communication units 2, and by setting and managing the communication units 2 in the virtual shelves 3. In the embodiment, up to six communication units 2 may belong to each of the virtual shelves 3, but the maximum number of communication units 2 belonging to each of the virtual shelves 3 is not limited.

As an example, communication units 2 that belong to each of the virtual shelves 3 are identified by interface IDs (INF-IDs) “#1” to “#6”. For example, one of the communication units 2 that are in the mode M1 and belong to the virtual shelf (#2) 3 is identified by an INF-ID “#1”, while the other one of the communication units 2 that are in the mode M1 and belong to the virtual shelf (#2) 3 is identified by an INF-ID “#3”. The physical arrangement of the communication units 2 is not limited, as described below.

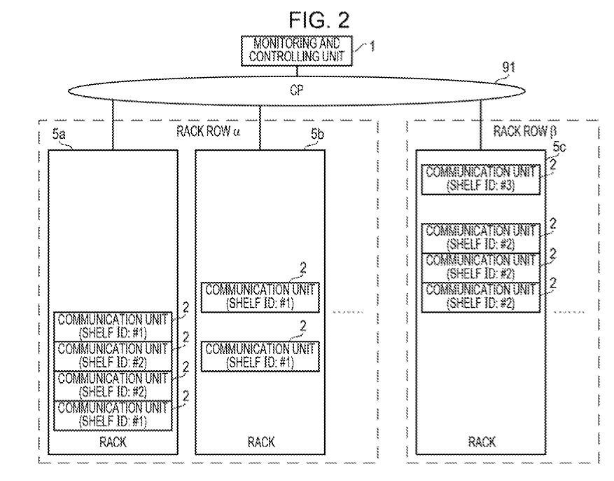

FIG. 2 is a configuration diagram illustrating an example of the physical arrangement of the communication units 2. The communication units 2 are attached to racks 5a to 5c. The racks 5a and 5b are arranged in the same rack row α, while the rack 5c is arranged in another rack row β.

FIG. 2 illustrates shelf IDs of virtual shelves 3 to which communication units 2 belong. Two communication units 2 that belong to each of the virtual shelves 3 with the shelf IDs “#1” and “#2” are attached to the rack 5a of the rack row α, while two communication units 2 that belong to the virtual shelf 3 with the shelf ID “#1” are attached to the rack 5b of the rack row α. In addition, three communication units 2 that belong to the virtual shelf 3 with the shelf ID “#2”, and one communication unit 2 that belongs to a virtual shelf 3 with a shelf ID “#3”, are attached to the rack 5c of the rack row β.

The communication units 2 within the racks 5a to 5c are, for example, coupled to a CP 91 via wirings of back surfaces of the racks 5a to 5c so that the communication units 2 communicate with a monitoring and controlling unit 1. Thus, the monitoring and controlling unit 1 may manage, as a common virtual shelf 3, communication units 2 attached at different positions within each of the racks 5a to 5c, communication units 2 within different racks among the racks 5a to 5c, or communication units 2 within racks that are among the racks 5a to 5c and arranged in the different rack rows α and β.

Thus, the communication units 2 may be treated as “location-free” communication devices of which the physical arrangement is not limited. The configurations of the communication units 2 are described below.

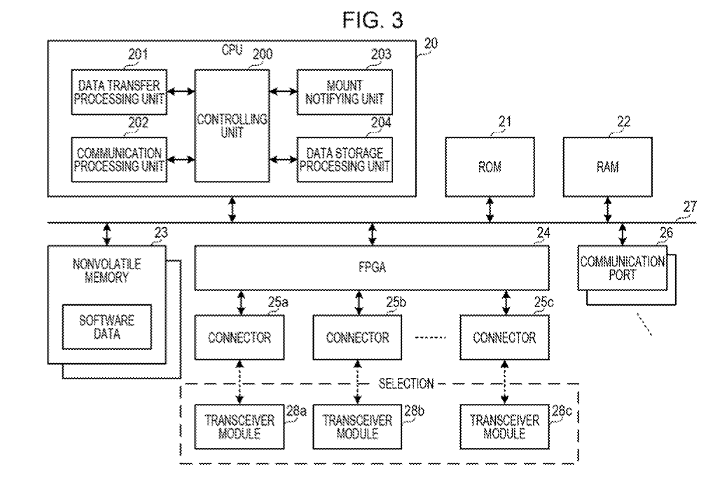

FIG. 3 is a configuration diagram illustrating an example of the communication units 2. Each of the communication units 2 includes a central processing unit (CPU) 20, a read only memory (ROM) 21, a random access memory (RAM) 22, redundant nonvolatile memories 23, an FPGA 24, multiple connectors 25a to 25c, and multiple communication ports 26. The CPU 20 is coupled via a data bus 27 to the ROM 21, the RAM 22, the nonvolatile memories 23, the FPGA 24, and the communication ports 26 so that the CPU 20, the ROM 21, the RAM 22, the nonvolatile memories 23, the FPGA 24, and the communication ports 26 are able to receive and output signals from and to each other via the data bus 27.

A program for driving the CPU 20 is stored in the ROM 21. The RAM 22 functions as a working area of the CPU 20. Software data that is used to cause the FPGA 24 and a communication process function of the CPU 20 to operate is stored in the nonvolatile memories 23. The software data includes circuit data on the FPGA 24 and firmware data on the communication process function of the CPU 20.

The communication ports 26 are, for example, physical layer (PHY)/media access control (MAC) devices. The communication ports 26 transmit and receive packets to and from external terminals, and transmit and receive packets to and from a monitoring and controlling unit 1 via a CP 91. In the embodiment, the packets are IP packets, but are not limited to this.

The FPGA 24 is coupled to the multiple connectors 25a to 25c. The FPGA 24 receives signals (hereinafter, referred to as client signals) of subscribers from the connectors 25a to 25c, and processes the received client signals, for example. The connectors 25a to 25c are provided for the modes M1, M2, and the like of the communication units 2, respectively. Transceiver modules 28a to 28c for the modes M1, M2, and the like are inserted into the connectors 25a to 25c, respectively. In the embodiment, the signals input from the connectors 25a to 25c are the client signals as an example, but are not limited to this.

Only selected one of the transceiver modules 28a to 28c is inserted in a connector 25a, 25b, or 25c corresponding to the selected one of the transceiver module 28a, 28b, or 28c (refer to “selection”). When any of the transceiver modules 28a to 28c is inserted in a connector 25a, 25b, or 25c corresponding to the selected one of the transceiver module 28a, 28b, or 28c, the FPGA 24 processes a client signal in accordance with a mode M1, M2, or the like corresponding to one of the connector 25a, 25b, or 25c to which the transceiver module has been inserted.

The transceiver modules 28a to 28c are SFP, for example. For example, when the transceiver module 28a is “smart SFP” (registered trademark) and is inserted in the connector 25a, the FPGA 24 is configured by Ethernet circuit data included in the software data. In this case, the FPGA 24 processes a client signal in accordance with the rules of Ethernet.

For example, when the transceiver module 28b is “Chameleon SFP” (registered trademark) and is inserted in the connector 25b, the FPGA 24 is configured by “10G-PON” circuit data included in the software data. In this case, the FPGA 24 processes a client signal in accordance with the rules of “10G-PON”. Instead of the FPGA 24, another device that may be configured by circuit data may be used.

When the CPU 20 reads the program from the ROM 21, a controlling unit 200, a data transfer processing unit 201, a mount notifying unit 203, and a data storage processing unit 204 are formed as functions in the CPU 20. When the CPU 20 reads the firmware data included in the software data, a communication processing unit 202 is formed as a function in the CPU 20. The communication processing unit 202 executes the communication process, based on the software data, similarly to the FPGA 24.

The controlling unit 200 controls overall operations of the communication unit 2 and provides various instructions and responses to the data transfer processing unit 201, the communication processing unit 202, the mount notifying unit 203, and the data storage processing unit 204.

The controlling unit 200 receives a setting process from a terminal via a communication port 26 upon the activation of the communication unit 2. Details of the setting process include an address of the communication unit 2, a shelf ID of a virtual shelf 3, a mode M1, M2, or the like, and a data ID identifying the type of software data to be applied, for example.

Upon the activation of the communication unit 2, the mount notifying unit 203 provides, to the monitoring and controlling unit 1, a mount notification indicating the mount of the communication unit 2. The mount notification includes information indicating the address, the shelf ID, the mode M1, M2, or the like, the data ID, and the like that were set in the setting process.

The data storage processing unit 204 executes a process of storing software data transferred from the monitoring and controlling unit 1 or storing software data transferred from another communication unit 2. For example, the data storage processing unit 204 acquires software data via a communication port 26 and causes the acquired software data to be stored in the nonvolatile memories 23. The nonvolatile memories 23 are made redundant and the software data is made redundant. The software data stored in the nonvolatile memories 23 are treated as data for an active system and data for a standby system, while details of the data for the active system are synchronized with details of the data for the standby system.

For example, a data ID that indicates the type of software data is stored in a header portion of the software data. The data storage processing unit 204 confirms whether or not the data ID of the software data received from the monitoring and controlling unit 1 or the data ID of the software data received from the other communication unit 2 corresponds to the mode M1, M2, or the like of the communication unit 2.

The controlling unit 200 loads the software data within a nonvolatile memory 23 into the RAM 22 and the FPGA 24. Thus, the FPGA 24 is configured by the circuit data included in the software data, and the communication processing unit 202 is formed by the firmware data included in the software data in the CPU 20. When completing the loading of the software data, the controlling unit 200 transmits, to the monitoring and controlling unit 1, a reception notification indicating that the software data was received. After that, the communication processing unit 202 and the FPGA 24 start the communication process.

When receiving an instruction from the monitoring and controlling unit 1, the controlling unit 200 instructs the data transfer processing unit 201 to transfer the software data to another communication unit 2. The data transfer processing unit 201 reads the software data from the nonvolatile memory 23 in accordance with the instruction from the controlling unit 200 and transfers the read software data to the other communication unit 2 via a communication port 26. In this case, an address of the destination communication unit 2 is included in the instruction to transfer the software data, for example. Next, the configurations of the monitoring and controlling units 1 are described.

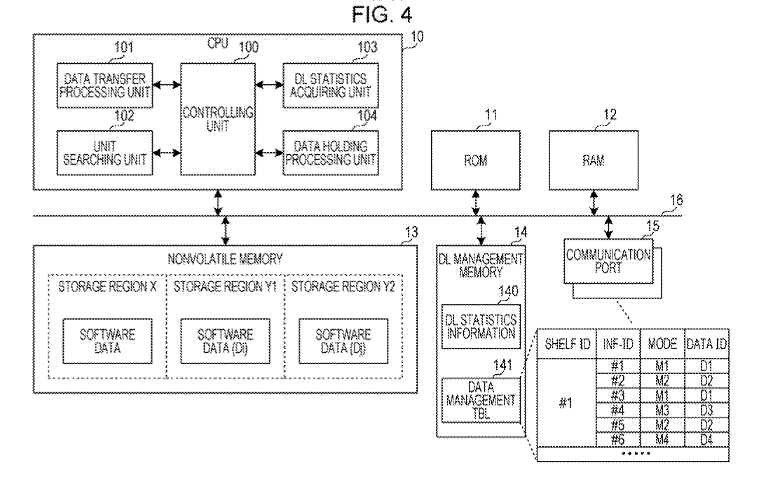

FIG. 4 is a configuration diagram illustrating an example of a monitoring and controlling unit 1. The monitoring and controlling unit 1 includes a CPU 10, a ROM 11, a RAM 12, a nonvolatile memory 13, a download (DL) management memory 14, and multiple communication ports 15. The CPU 10 is coupled via a data bus 16 to the ROM 11, the RAM 12, the nonvolatile memory 13, the DL management memory 14, and the communication ports 15 so that the CPU 10, the ROM 11, the RAM 12, the nonvolatile memory 13, the DL management memory 14, and the communication ports 15 are able to receive and output signals from and to each other via the data bus 16.

A program for driving the CPU 10 is stored in the ROM 11. The RAM 12 functions as a working memory of the CPU 10. The communication ports 15 are, for example, PHY/MAC devices. The communication ports 15 transmit and receive packets to and from communication units 2 via a CP 91, and transmit and receive packets to and from the NW managing device 4 via the CP 90. In the embodiment, the packets are IP packets as an example, but are not limited to this.

Software data that is used for the communication units 2 is stored in the nonvolatile memory 13. The nonvolatile memory 13 has regions X, Y1, and Y2 for storing software data as an example. In the storage region X, software data transferred from the NW managing device 4 is temporarily stored. The software data within the storage region X is transferred to a target communication unit 2.

In the storage regions Y1 and Y2, reserve software data with data IDs “Di” and “Dj” (i and j are positive integers) is stored. When a new communication unit 2 is added to a virtual shelf 3 to be monitored and controlled and one of the data IDs “Di” and “Dj” corresponds to a mode M1, M2, or the like of the new communication unit 2, reserve software data with the data ID corresponding to the mode M1, M2, or the like of the new communication unit 2 is transferred to the new communication unit 2. The data IDs “Di” and “Dj” are determined based on download (DL) statistics information 140 held in the DL management memory 14.

In the embodiment, the two storage regions Y1 and Y2 for storing reserve software data are provided. Three or more storage regions for storing reserve software data may be provided. It is preferable that the memory capacity of the nonvolatile memory 13 be reduced in order to reduce the cost of the monitoring and controlling unit 1. It is, therefore, preferable that the storage regions Y1 and Y2 be small.

In the DL management memory 14, a DL statistics information 140 and a data management table (TBL) 141 are stored. The DL statistics information 140 is an example of data information and is information on types of software data to be transferred from the monitoring and controlling unit 1 to the communication units 2. The DL statistics information 140 is used to select types of reserve software data to be held in the storage regions Y1 and Y2 of the nonvolatile memory 13 or select the data IDs “Di” and “Dj”.

In the data management TBL 141, types of software data held in the communication units 2 belonging to virtual shelves 3 to be monitored and controlled, or data IDs, are registered. Specifically, in the data management TBL 141, shelf IDs, INF-IDs, modes, and the data IDs are associated with each other and registered.

In the example illustrated in FIG. 4, a communication unit 2 with an INF-ID “#1” associated with a shelf ID “#1” is in the mode M1 and holds software data with a data ID “D1”. In addition, a communication unit 2 with an INF-ID “#2” associated with the shelf ID “#1” is in the mode M2 and holds software data with a data ID “D2”. Data IDs indicate not only types corresponding to the modes M1, M2, and the like but also types including versions of the software data.

Thus, the types of the software data held in the communication units 2 belonging to the virtual shelves 3 to be monitored and controlled may be detected based on the data management TBL 141. The DL management memory 14 is an example of a storage unit.

When the CPU 10 reads the program from the ROM 11, a controlling unit 100, a data transfer processing unit 101, a unit searching unit 102, a download (DL) statistics acquiring unit 103, and a data holding processing unit 104 are formed as functions in the CPU 10.

The controlling unit 100 controls overall operations of the monitoring and controlling unit 1, and provides various instructions and responses to the data transfer processing unit 101, the unit searching unit 102, the DL statistics acquiring unit 103, and the data holding processing unit 104. When a communication unit 2 is activated, the controlling unit 100 receives a mount notification from the communication unit 2 via a communication port 15. The controlling unit 100 acquires information of various types from the mount notification and registers the acquired information in the data management TBL 141.

When the monitoring and controlling system is activated, the controlling unit 100 detects the mount of the communication units 2, based on mount notifications, and instructs the data transfer processing unit 101 to transfer software data to the communication units 2. The data transfer processing unit 101 is an example of a transfer processing unit. The data transfer processing unit 101 transfers the software data to the communication units 2 belonging to the virtual shelves 3 to be monitored and controlled, in accordance with the transfer instruction from the controlling unit 100.

The DL statistics acquiring unit 103 is an example of an acquiring unit. The DL statistics acquiring unit 103 acquires the DL statistics information 140 on types of the software data transferred by the data transfer processing unit 101. The DL statistics acquiring unit 103 writes the acquired DL statistics information 140 in the DL management memory 14.

The data holding processing unit 104 is an example of a holding unit. The data holding processing unit 104 selects and holds, based on the DL statistics information 140, software data of types satisfying a predetermined requirement. Specifically, the data holding processing unit 104 determines, based on the DL statistics information 140, the data IDs “Di” and “Dj” of the reserve software data satisfying the predetermined requirement, acquires the corresponding software data from the NW managing device 4, and writes the acquired software data in the storage regions Y1 and Y2 of the nonvolatile memory 13.

The DL statistics information 140 indicates the number of communication units 2 holding software data for each of data IDs, or the frequency at which the data transfer processing unit 101 downloads software data for each of the data IDs, or the size of software data for each of the data IDs, for example. Examples of the DL statistics information 140 are described below.

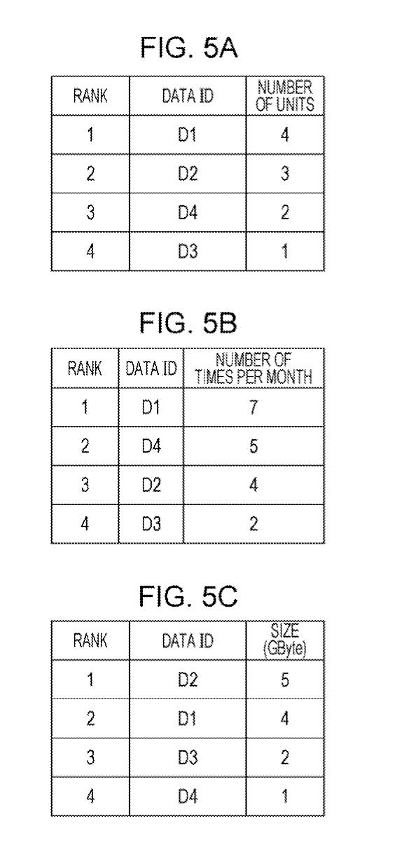

FIG. 5A illustrates an example of the DL statistics information 140 that indicates, for each of types of software data, the number of communication units holding the software data of each type. In this example, the DL statistics acquiring unit 103 acquires the DL statistics information 140 indicating, for each type of the software data, the number of communication units 2 to be monitored and controlled, which hold the software data of the each type.

Specifically, the DL statistics information 140 indicates the number of communication units 2 for each of data IDs. For example, the number of communication units 2 that hold the software data with the data ID “D1” is 4, and the number of communication units 2 that hold the software data with the data ID “D2” is 3. In addition, the number of communication units 2 that hold software data with a data ID “D4” is 2, and the number of communication units 2 that hold software data with a data ID “D3” is 1.

The data holding processing unit 104 selects and holds, based on the DL statistics acquiring unit 103, software data of a type associated with a rank (refer to “rank”) based on the number of communication units 2 to be monitored and controlled. In this example, the data holding processing unit 104 selects the software data with the data ID “D1” ranked in first place and the software data with the data ID “D2” ranked in second place, and holds the selected software data in the storage regions Y1 and Y2 of the nonvolatile memory 13.

Specifically, the data IDs “D1” and “D2” are selected as the data IDs “Di” and “Dj” of the reserve software data. Thus, the software data that is used for the communication units 2 of which the numbers are larger than the numbers of the other communication units 2 for which the software data of the other types is used is selected as the reserve software data.

In addition, FIG. 5B illustrates an example of the DL statistics information 140 indicating a frequency at which the software data is downloaded for each of types of the software data. In this example, the DL statistics acquiring unit 103 acquires the DL statistics information 140 indicating, for each type of the software data, the frequency at which the software data of the each type is transferred by the data transfer processing unit 101.

Specifically, the DL statistics information 140 indicates, for each of the data IDs, the number (number of times per month) of times when software data with the data ID is downloaded per month. For example, the number of times when the software data with the data ID “D1” is downloaded is 7 (times per month), and the number of times when the software data with the data ID “D4” is downloaded is 5 (times per month). In addition, the number of times when the software data with the data ID “D2” is downloaded is 4 (times per month), and the number of times when the software data with the data ID “D3” is downloaded is 2 (times per month). The frequency at which the software data is downloaded is not limited to the number of times when the software data is downloaded per month. The frequency at which the software data is downloaded may be the number of times when the software data is downloaded per day or may be the cumulative numbers of times when the software data is downloaded after the initial activation of the monitoring and controlling unit 1.

The data holding processing unit 104 selects and holds, based on the DL statistics acquiring unit 103, software data of a type associated with a rank (refer to “rank”) based on the frequency at which the software data of the type is downloaded. In this example, the data holding processing unit 104 selects the software data with the data ID “D1” ranked in first place and the software data with the data ID “D4” ranked in second place, and holds the selected software data in the storage regions Y1 and Y2 of the nonvolatile memory 13.

Specifically, the data IDs “D1” and “D4” are selected as the data IDs “Di” and “Dj” of the reserve software data. Thus, the software data of the type that is downloaded more frequently than the software data of the other types is selected as the reserve software data.

In addition, FIG. 5C illustrates an example of the DL statistics information 140 indicating a size of software data for each of types of software data. In this example, the DL statistics acquiring unit 103 acquires the DL statistics information 140 indicating, for each of types of software data, a size of the software data of the each type.

Specifically, the DL statistics information 140 indicates a size (G bytes) of software data for each of the data IDs. For example, the size of the software data with the data ID “D2” is 5 G bytes, and the size of the software data with the data ID “D1” is 4 G bytes. In addition, the size of the software data with the data ID “D3” is 2 G bytes, and the size of the software data with the data ID “D4” is 1 G bytes.

The data holding processing unit 104 selects and holds, based on the DL statistics acquiring unit 103, software data of a type associated with a rank (refer to rank) based on the size of the software data of the type. In this example, the data holding processing unit 104 selects the software data with the data ID “D2” ranked in first place and the software data with the data ID “D1” ranked in second place, and holds the selected software data in the storage regions Y1 and Y2 of the nonvolatile memory 13.

Specifically, the data IDs “D2” and “D1” are selected as the data IDs “Di” and “Dj” of the reserve software data. Thus, the software data of which the sizes are larger than the software data of the other types is selected as the reserve software data. This allows a time for downloading the software data from the NW managing device 4 to the monitoring and controlling unit 1 to be reduced, and allows a traffic load in the CP 90 to be reduced.

At least two types of the DL statistics information 140 illustrated in FIGS. 5A to 5C may be combined and used. For example, if three storage regions are provided instead of the storage regions Y1 and Y2 for storing reserve software data in a different manner from the example illustrated in FIG. 4, the software data with the data ID “D1” (ranked in first place in FIG. 5A), the software data with the data ID “D4” (ranked in second place in FIG. 5B), and the software data with the data ID “D2” (ranked in first place in FIG. 5C) may be selected based on ranks illustrated in FIGS. 5A to 5C.

Refer to FIG. 4 again. When a new communication unit 2 is added to a virtual shelf 3 to be monitored after the activation of the monitoring and controlling system, the controlling unit 100 instructs the unit searching unit 102 to search a communication unit 2 holding software data of the same type as software data that is used for the new communication unit 2. In this case, the controlling unit 100 acquires a data ID from a mount notification provided by the new communication unit 2, and notifies the unit searching unit 102 of the acquired data ID.

The unit searching unit 102 is an example of a searching unit. When the new communication unit 2 is added to the virtual shelf 3 to be monitored and controlled, the unit searching unit 102 searches, from the DL management memory 14, the communication unit 2 holding the software data of the same type as the software data that is used for the new communication unit 2. Specifically, the unit searching unit 102 searches the data management TBL 141 for the communication unit 2 holding the same data ID as the data ID held in the new communication unit 2 in accordance with the search instruction from the controlling unit 100. The unit searching unit 102 notifies the controlling unit 100 of a shelf ID and INF-ID of the communication unit 2 holding the same data ID as the data ID held in the new communication unit 2.

The controlling unit 100 is an example of an instructing unit. The controlling unit 100 instructs the communication unit 2 searched by the unit searching unit 102, to transfer the software data to the new communication unit 2. Specifically, the controlling unit 100 transmits an instruction to transfer the software data via a communication port 15 to the communication unit 2 corresponding to the shelf ID and INF-ID, notified by the unit searching unit 102, of the communication unit 2. The transfer instruction includes an address of the new communication unit 2 that was acquired from the mount notification provided by the new communication unit 2.

In the aforementioned manner, the controlling unit 100 instructs the communication unit 2 holding the software data of the same type as the software data that is used for the new communication unit 2, to transfer the software data to the new communication unit 2. This allows the monitoring and controlling unit 1 to eliminate the need for holding software data of all types corresponding to all the modes M1, M2, and the like, thereby reducing a capacity needed for storing software data.

When a corresponding communication unit 2 is not found by the unit searching unit 102, in other words, when a communication unit 2 that holds the same data ID as the data ID of the software data that is used for the new communication unit 2 does not exist, the controlling unit 100 instructs the data transfer processing unit 101 to transfer the reserve software data. The data transfer processing unit 101 compares the data IDs “Di” and “Dj” of the reserve software data within the storage regions Y1 and Y2 of the nonvolatile memory 13 with the data ID of the software data that is used for the new communication unit 2.

When one of the data IDs “Di” and “Dj” of the reserve software data matches the data ID of the software data that is used for the new communication unit 2, the data transfer processing unit 101 transfers the reserve software data with the matched data ID to the new communication unit 2 via a communication port 15. The data ID of the software data that is used for the new communication unit 2 is acquired from the mount notification provided by the new communication unit 2.

In this way, when a communication unit 2 that holds software data of the same type as software data that is used for a new communication unit 2 does not exist and the type of the software data that is used for the new communication unit 2 matches one of the types of the reserve software data, the data transfer processing unit 101 transfers the reserve software data of the matched type to the new communication unit 2. Thus, the monitoring and controlling unit 1 does not acquire the software data from the NW managing device 4, and may transfer the software data to the new communication unit 2 within a short time period without applying a traffic load to the CP 90.

When the type of the software data that is used for the new communication unit 2 does not match any of the types of the reserve software data, the data transfer processing unit 101 acquires, from the NW managing device 4, the software data that is used for the new communication unit 2 and the data transfer processing unit 101 transfers the acquired software data to the new communication unit 2 via the storage region X of the nonvolatile memory 13. Thus, even if the software data of the same type as the software data that is used for the new communication unit 2 exists neither in any of communication units 2 to be monitored and controlled nor in the storage regions Y1 and Y2 of the nonvolatile memory 13, the monitoring and controlling unit 1 may transfer the software data to the new communication unit 2.

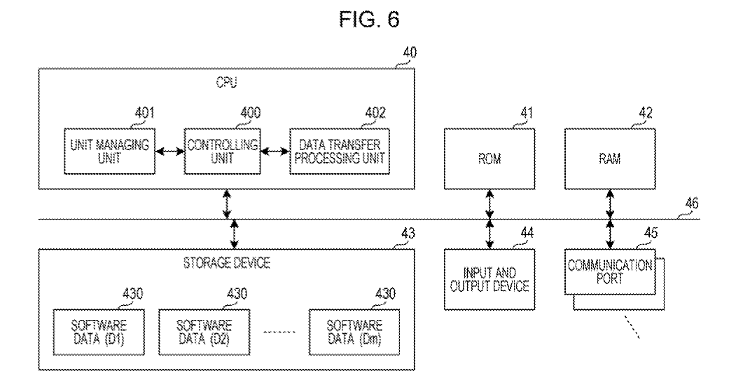

FIG. 6 is a configuration diagram illustrating an example of a network managing device 4. The network managing device 4 includes a CPU 40, a ROM 41, a RAM 42, a memory device 43, an input and output device 44, and multiple communication ports 45. The CPU 40 is coupled to the ROM 41, the RAM 42, the memory device 43, the input and output device 44, and the communication ports 45 via a data bus 46 so that the CPU 40, the ROM 41, the RAM 42, the memory device 43, the input and output device 44, and the communication ports 45 receive and output signals from and to each other via the data bus 46.

A program for driving the CPU 40 is stored in the ROM 41. The RAM 42 functions as a working memory of the CPU 40. The communication ports 45 are, for example, PHY/MAC devices, and transmit and receive packets to and from the monitoring units 1 via the CP 90.

The memory device 43 is, for example, a storage device and has a large memory capacity (of, for example, 1 T bytes or greater). In the memory device 43, the software data (with data IDs “D1” to “Dm” (m is a positive integer)) of all the types corresponding to all the modes M1, M2, and the like of the communication units 2 is stored. The software data stored in the memory device 43 is transferred to the communication units 2 via the monitoring and controlling units 1.

The input and output device 44 includes, for example, a keyboard, a mouse, a display, and the like, and is used for an operation by an operator.

When the CPU 40 reads the program from the ROM 41, a controlling unit 400, a unit managing unit 401, and a data transfer processing unit 402 are formed as functions in the CPU 40.

The controlling unit 400 controls overall operations of the NW managing device 4, and provides various instructions and responses to the unit managing unit 401 and the data transfer processing unit 402. The unit managing unit 401 manages the communication units 2 to be monitored and controlled by the monitoring and controlling units 1 coupled to the NW managing device 4. The unit managing unit 401 receives, from the monitoring and controlling units 1 via the communication ports 45, a mount detection notification indicating that the mount of a communication unit 2 was detected, and the unit managing unit 401 registers the communication unit 2 in a database, based on the mount detection notification, and manages the communication unit 2.

The data transfer processing unit 402 reads, from the memory device 43, software data in accordance with a request from a monitoring and controlling unit 1, and transfers the read software data to the monitoring and controlling unit 1. The request from the monitoring and controlling unit 1 includes a data ID of the desired software data. The data transfer processing unit 402 selects and transfers the software data corresponding to the data ID. Upon the activation of the monitoring and controlling system, the data transfer processing unit 402 sequentially transfers the software data for the communication units 2 to be monitored and controlled by the monitoring and controlling units 1.

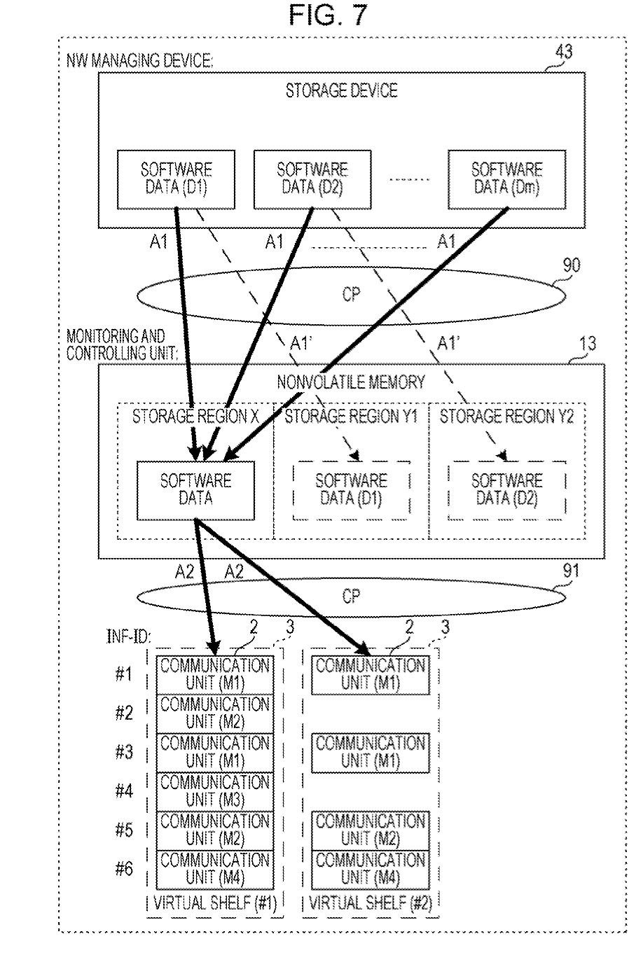

FIG. 7 illustrates an example of operations for transferring the software data upon the activation of the monitoring and controlling system. In FIG. 7, configurations that are common to those illustrated in FIGS. 1, 3, 4, and 6 are indicated by the same reference numerals and symbols as those illustrated in FIGS. 1, 3, 4, and 6, and a description thereof is omitted. FIG. 7 illustrates operations for transferring software data to communication units 2 belonging to the virtual shelves (#1 and #2) 3.

When the monitoring and controlling system is activated, the NW managing device 4 reads software data from the memory device 43 in accordance with a request from a monitoring and controlling unit 1, and transfers the read software data to the monitoring and controlling unit 1 via the CP 90, as indicated by arrows A1. The transferred software data is temporarily stored in the storage region X of the nonvolatile memory 13. The monitoring and controlling unit 1 reads the software data from the storage region X and transfers the read software data via a CP 91 to the corresponding communication units 2 among communication units 2 to be monitored and controlled, as indicated by arrows A2.

After the monitoring and controlling unit 1 transfers software data to all the communication units 2 to be monitored and controlled, the monitoring and controlling unit 1 determines data IDs of reserve software data, based on the DL statistics information 140. The monitoring and controlling unit 1 requests the NW managing device 4 to transmit the software data with the determined data IDs. This example assumes that the data IDs “D1” and “D2” are determined as the data IDs of the reserve software data.

The NW managing device 4 transfers the software data with the data IDs “D1” and “D2” to the monitoring and controlling unit 1 in accordance with the request from the monitoring and controlling unit 1, as indicated by arrows A1′. The transferred software data is stored as the reserve software data in the storage regions Y1 and Y2 of the nonvolatile memory 13.

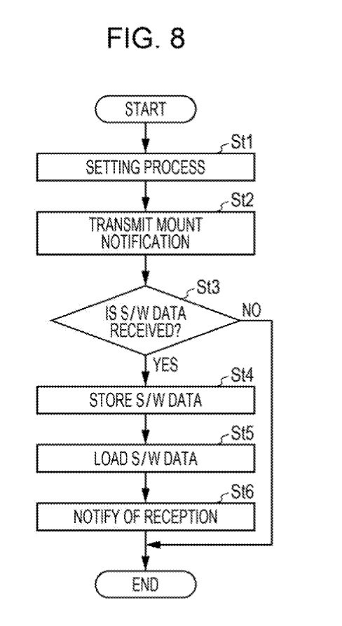

FIG. 8 is an operational flowchart of an example of a process to be executed by each of the communication units 2 upon the activation. First, the controlling unit 200 of the communication unit 2 executes the setting process based on an operation by an external terminal (in step St1). As described above, details of the setting process include an address of the communication unit 2, a shelf ID of a virtual shelf 3, a mode M1, M2, or the like, and a data ID, for example.

Next, the mount notifying unit 203 transmits a mount notification including information on the details of the setting process to a monitoring and controlling unit 1 (in step St2). Then, the data storage processing unit 204 determines whether or not the communication unit 2 received software data (S/W data) from the monitoring and controlling unit 1 (in step St3). When the communication unit 2 has not received the software data (No in step St3), the communication unit 2 terminates the process. In this case, the data storage processing unit 204 may output an alert to the monitoring and controlling unit 1.

When the communication unit 2 has received the software data (Yes in step St3), the data storage processing unit 204 causes the software data to be stored in the nonvolatile memories 23 (in step St4). Then, the controlling unit 200 loads the software data into the FPGA 24 and the RAM 22 (in step St5). Then, the communication processing unit 202 and the FPGA 24 start the communication process.

Next, the controlling unit 200 notifies the monitoring and controlling unit 1 that the communication unit 2 has normally received the software data (in step St6), and the controlling unit 200 terminates the process. In this manner, the communication unit 2 executes the process upon the activation.

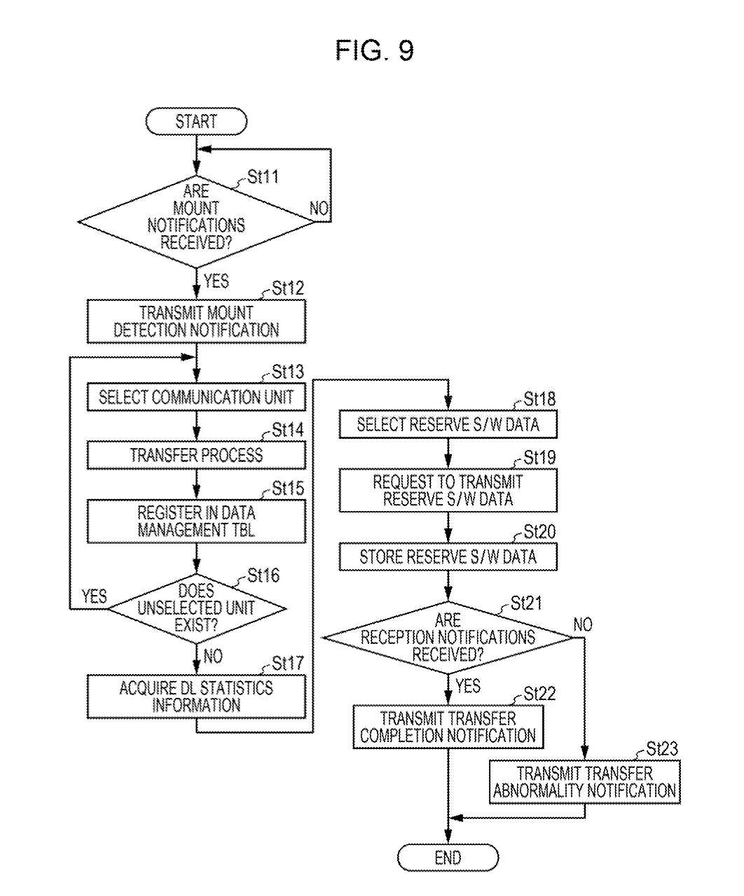

FIG. 9 is an operational flowchart of an example of a process to be executed by each of the monitoring and controlling units 1 upon the activation. The controlling unit 100 of the monitoring and controlling unit 1 determines whether or not the monitoring and controlling unit 1 has received mount notifications from communication units 2 (in step St11). When the monitoring and controlling unit 1 has not received the mount notifications (No in step St11), the controlling unit 100 executes the determination process of step St11 again.

When the monitoring and controlling unit 1 has received the mount notifications (Yes in step St11), the controlling unit 100 transmits a mount detection notification to the NW managing device 4 (in step St12). Then, the controlling unit 100 selects one of the communication units 2 from which the monitoring and controlling unit 1 has received the mount notifications (in step St13). The controlling unit 100 notifies the data transfer processing unit 101 of an address of the selected communication unit 2 as an instruction to transfer software data.

Next, the data transfer processing unit 101 transfers the software data to the selected communication unit 2 (in step St14). Then, the controlling unit 100 registers, in the data management TBL 141, information included in the mount notification provided by the communication unit 2 (in step St15).

Then, the controlling unit 100 determines whether or not an unselected communication unit 2 exists among the communication units 2 from which the monitoring and controlling unit 1 has received the mount notifications (in step St16). When the unselected communication unit 2 exists (Yes in step St16), the controlling unit 100 executes the process of step St13 again. When the unselected communication unit 2 does not exist (No in step St16), the DL statistics acquiring unit 103 acquires the DL statistics information 140 from transfer history records of the data transfer processing unit 101 (in step St17).

Then, the data holding processing unit 104 selects, based on the DL statistics information 140, software data of types satisfying the predetermined requirement described with reference to FIGS. 5A to 5C (in step St18). Then, the data holding processing unit 104 requests the NW managing device 4 to transfer the selected reserve software data (in step St19). The data holding processing unit 104 causes the software data transferred from the NW managing device 4 to be stored in the storage regions Y1 and Y2 of the nonvolatile memory 13 (in step St20).

Then, the controlling unit 100 determines whether or not the monitoring and controlling unit 1 has received, from the communication units 2, a reception notification indicating that the communication unit 2 has received software data (in step St21). When the monitoring and controlling unit 1 has received the reception notification (Yes in step St21), the controlling unit 100 transmits a transfer completion notification to the NW managing device 4 (in step St22) and terminates the process. When the monitoring and controlling unit 1 has failed to receive the reception notification (No in step St21), the controlling unit 100 transmits a transfer abnormality notification to the NW managing device 4 (in step St23) and terminates the process. In this manner, the monitoring and controlling unit 1 executes the process.

In a case where a new communication unit 2 is added to a virtual shelf 3 to be monitored and controlled after the activation of the monitoring and controlling system, and a communication unit 2 that holds software data of the same type as software data that is used for the new communication unit 2 exists, the monitoring and controlling unit 1 instructs the communication unit 2 to transfer the software data. This operation is described below.

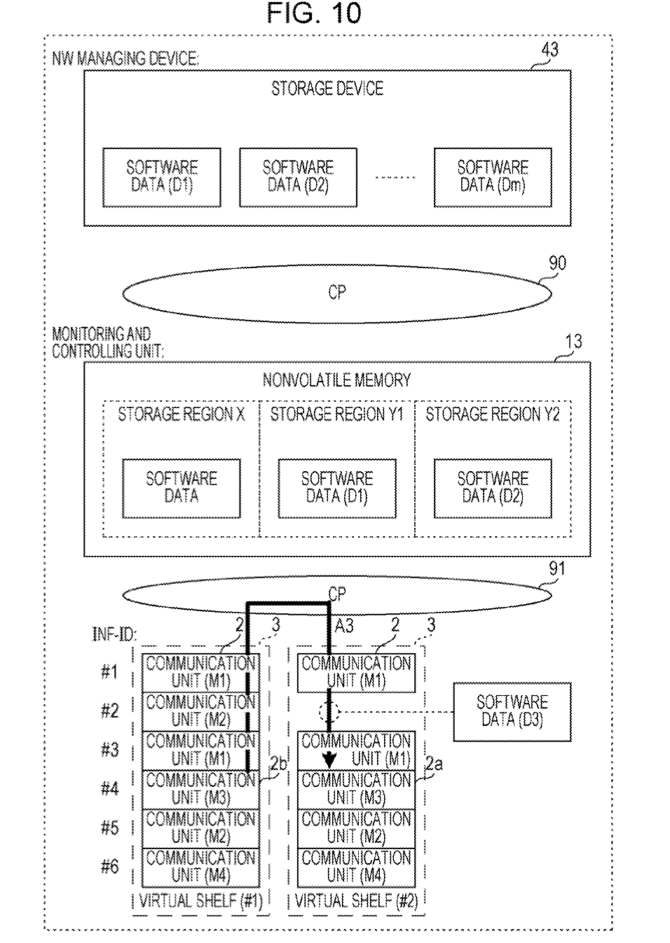

FIG. 10 illustrates an example of the operation for transferring the software data between the communication units 2. In FIG. 10, configurations that are common to those illustrated in FIG. 7 are indicated by the same reference numerals and symbols as those illustrated in FIG. 7, and a description thereof is omitted.

FIG. 10 illustrates an example in which a new communication unit 2a in the mode M3 is added to the virtual shelf (#2) 3. The monitoring and controlling unit 1 searches the data management TBL 141 for an existing communication unit 2b holding software data of the same type as software data that is used for the new communication unit 2a. The existing communication unit 2b operates in the same mode M3 as the new communication unit 2a.

The monitoring and controlling unit 1 instructs the communication unit 2b belonging to the virtual shelf (#1) 3 to transfer the software data to the new communication unit 2a. Thus, the software data with the data ID “D3” for the mode M3 is transferred from the existing communication unit 2b to the new communication unit 2a, as indicated by an arrow A3.

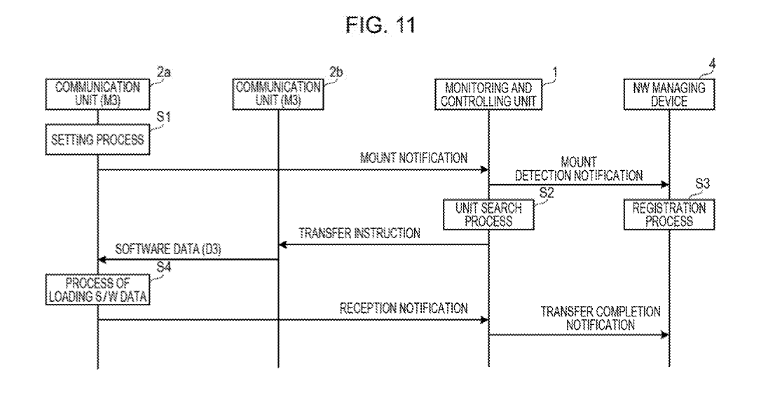

FIG. 11 is a sequence diagram illustrating an example of a process to be executed by the monitoring and controlling system in the case where the software data is transferred between the communication units 2a and 2b. First, the new communication unit 2a executes the setting process, based on an operation by an external terminal (refer to reference symbol S1), and transmits a mount notification to the monitoring and controlling unit 1.

When receiving the mount notification, the monitoring and controlling unit 1 transmits a mount detection notification to the NW managing device 4. When receiving the mount detection notification, the NW managing device 4 executes a process of registering the new communication unit 2a (refer to reference symbol S3).

Then, the monitoring and controlling unit 1 searches the data management TBL 141 for the existing communication unit 2b holding the software data of the same type as the software data that is used for the new communication unit 2a (refer to reference symbol S2). Then, the monitoring and controlling unit 1 instructs the searched existing communication unit 2b to transfer the software data. The existing communication unit 2b transfers the software data held in the existing communication unit 2b and having the data ID “D3”, to the new communication unit 2a in accordance with the transfer instruction.

When receiving the software data from the existing communication unit 2b, the new communication unit 2a executes a process of loading the software data (refer to reference symbol S4). Then, the new communication unit 2a transmits, to the monitoring and controlling unit 1, a reception notification indicating that the new communication unit 2a has received the software data. When receiving the reception notification, the monitoring and controlling unit 1 transmits a transfer completion notification to the NW managing device 4. In this manner, the software data is transferred between the communication units 2a and 2b.

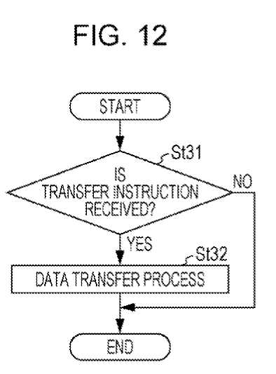

FIG. 12 is an operational flowchart of an example of a process to be executed by the communication unit 2b upon the reception of the instruction to transfer the software data. This process is executed at intervals of a certain time period. First, the data transfer processing unit 201 of the communication unit 2b determines whether or not the communication unit 2b has received the instruction to transfer the software data from the monitoring and controlling unit 1 (in step St31).

When the communication unit 2b has not received the transfer instruction (No in step St31), the data transfer processing unit 201 terminates the process. When the communication unit 2b has received the transfer instruction (Yes in step St31), the data transfer processing unit 201 reads the software data from a nonvolatile memory 23, transfers the read software data to the new communication unit 2a (in step St32), and terminates the process. The File Transfer Protocol (FTP) is used for the transfer of the software data, for example. In this manner, the communication unit 2b executes the process.

In this manner, the existing communication unit 2b transfers the software data held in the existing communication unit 2b to the new communication unit 2a in accordance with the instruction from the controlling unit 100 of the monitoring and controlling unit 1. In addition, the new communication unit 2a executes the process illustrated in FIG. 8 and holds the software data transferred from the existing communication unit 2b.

In this example, the monitoring and controlling unit 1 enables the software data to be transferred between the communication units 2a and 2b without holding the software data of all the types. Thus, in the monitoring and controlling unit 1, a capacity needed for storing software data may be reduced.

In this example, since the software data is transferred between the communication units 2a and 2b, communication is not executed via the monitoring and controlling unit 1 through the CP 90. Thus, a traffic load in the CP 90 is reduced and a time period for the transfer is reduced, compared with a case where a process of transferring software data from the monitoring and controlling unit 1 is executed. Further, in the aforementioned example, since the software data is copied between the communication units 2a and 2b in the same mode M3, a task of managing versions of the software data is reduced.

When a communication unit 2b that holds the software data of the same type as the software data that is used for the new communication unit 2a does not exist, the monitoring and controlling unit 1 searches for the data IDs of the reserve software data. When the data ID of the software data that is used for the new communication unit 2a matches one of the data IDs of the reserve software data, that is, when the type of the software data that is used for the new communication unit 2a matches one of the types of the reserve software data, the monitoring and controlling unit 1 transfers the reserve software data with the matched data ID to the new communication unit 2a.

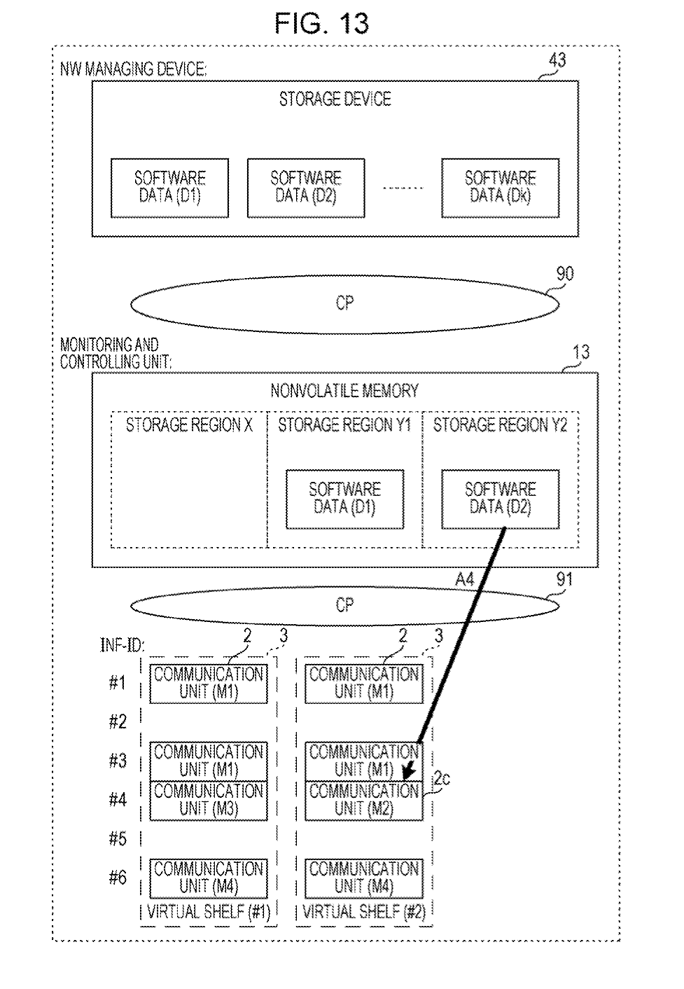

FIG. 13 illustrates an example of an operation for transferring the reserve software data from the monitoring and controlling unit 1 to a communication unit 2. In FIG. 13, configurations that are common to those illustrated in FIG. 7 are indicated by the same reference numerals and symbols as those illustrated in FIG. 7, and a description thereof is omitted.

In this example, a new communication unit 2c in the mode M2 is added to the virtual shelf (#2) 3. This example assumes that a communication unit 2 that holds software data of the same type as the software data that is used for the new communication unit 2c and has the data ID “D2” does not exist in the virtual shelves (#1 and #2) 3.

In this case, the monitoring and controlling unit 1 searches the storage region Y2 of the nonvolatile memory 13 for the reserve software data that has the data ID “D2” and is of the same type as the software data that is used for the new communication unit 2c. The monitoring and controlling unit 1 transfers the found reserve software data to the new communication unit 2c, as indicated by an arrow A4.

In this example, since the monitoring and controlling unit 1 does not acquire the software data from the NW managing device 4, the monitoring and controlling unit 1 transfers the software data to the new communication unit 2c within a short time period without applying a traffic load to the CP 90.

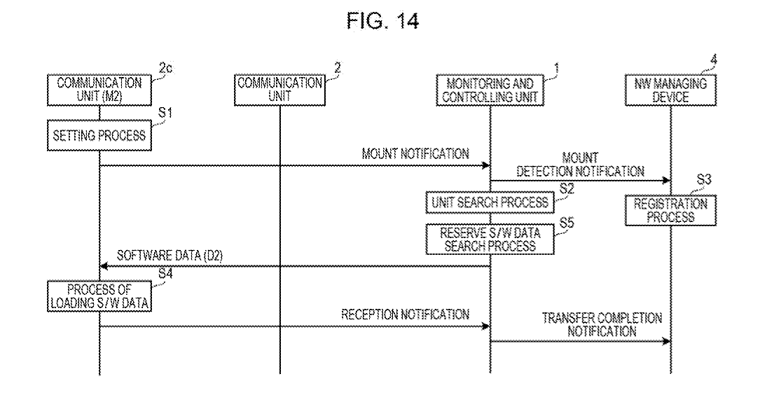

FIG. 14 is a sequence diagram illustrating an example of a process to be executed by the monitoring and controlling system in the case where the reserve software data is transferred from the monitoring and controlling unit 1 to the communication unit 2. In FIG. 14, processes that are common to those illustrated in FIG. 11 are indicated by the same reference symbols as those illustrated in FIG. 11, and a description thereof is omitted.

When a communication unit 2 that holds the software data of the same type as the software data that is used for the new communication unit 2c is not found as a result of the search process S2, the monitoring and controlling unit 1 searches the data management TBL 141 for the reserve software data stored in the storage regions Y1 and Y2 of the nonvolatile memory 13 (refer to reference symbol S5). The monitoring and controlling unit 1 transfers, to the new communication unit 2c, the reserve software data (with the data ID “D2”) of the type matching the software data that is used for the new communication unit 2c. After that, the same processes as those illustrated in FIG. 11 are executed. In this manner, the reserve software data is transferred from the monitoring and controlling unit 1 to the communication unit 2c.

When the reserve software data of the same type as the software data that is used for the new communication unit 2c does not exist, the monitoring and controlling unit 1 acquires the desired software data from the NW managing device 4, and transfers the acquired software data to the new communication unit 2c. Specifically, the software data is transferred from the NW managing device 4 to the new communication unit 2c via the monitoring and controlling unit 1.

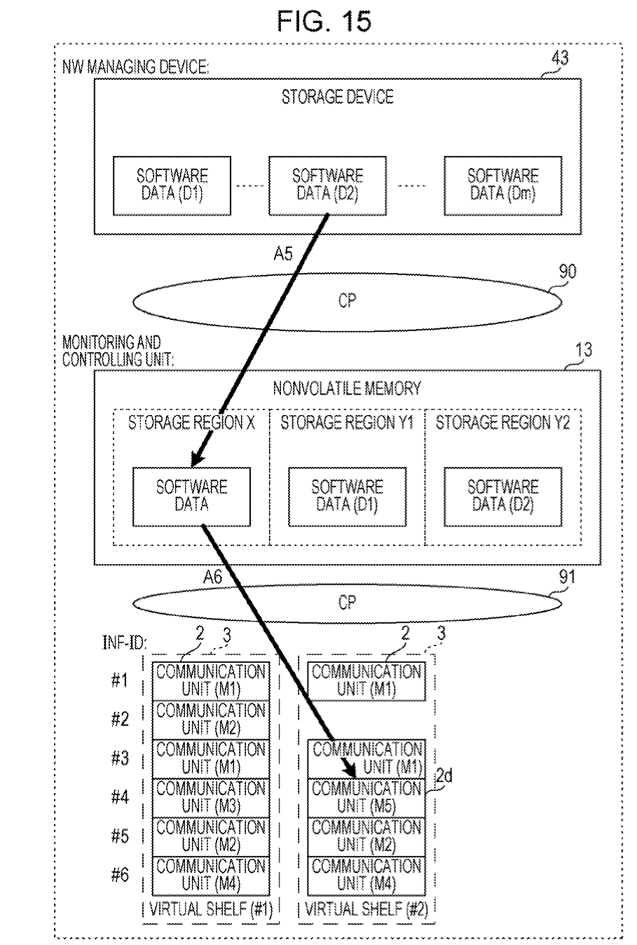

FIG. 15 illustrates an example of operations for transferring software data from the NW managing device 4 to a new communication unit 2. In FIG. 15, configurations that are common to those illustrated in FIG. 7 are indicated by the same reference numerals and symbols as those illustrated in FIG. 7, and a description thereof is omitted.

In this example, a new communication unit 2d in a mode M5 is added to the virtual shelf (#2) 3. This example assumes that a communication unit 2 that holds software data of the same type as software data that is used for the new communication unit 2d and has a data ID “D5” does not exist in the virtual shelves (#1 and #2) 3. In addition, this example assumes that the data IDs “D1” and “D2” of the reserve software data stored in the storage regions Y1 and Y2 of the nonvolatile memory 13 are different from the data ID “D5” of the software data that is used for the new communication unit 2d.

Since the type (data ID) of the software data that is used for the new communication unit 2d does not match the reserve software data and software data that is used for existing communication units 2 to be monitored and controlled, the monitoring and controlling unit 1 requests the NW managing device 4 to transmit the corresponding software data. The NW managing device 4 transmits the software data with the data ID “D5” to the monitoring and controlling unit 1 via the CP 90 in accordance with the request, as indicated by an arrow A5. The transmitted software data is temporarily stored in the storage region X of the nonvolatile memory 13.

The monitoring and controlling unit 1 reads the software data from the storage region X, and transfers the read software data to the new communication unit 2d via the CP 91, as indicated by an arrow A6. Thus, even if the software data that is of the same type as the software data that is used for the new communication unit 2d exists neither in the storage regions Y1 and Y2 of the nonvolatile memory 13 nor in the existing communication units 2 to be monitored and controlled, the monitoring and controlling unit 1 may acquire the software data from the NW managing device 4, and transfer the acquired software data to the new communication unit 2d.

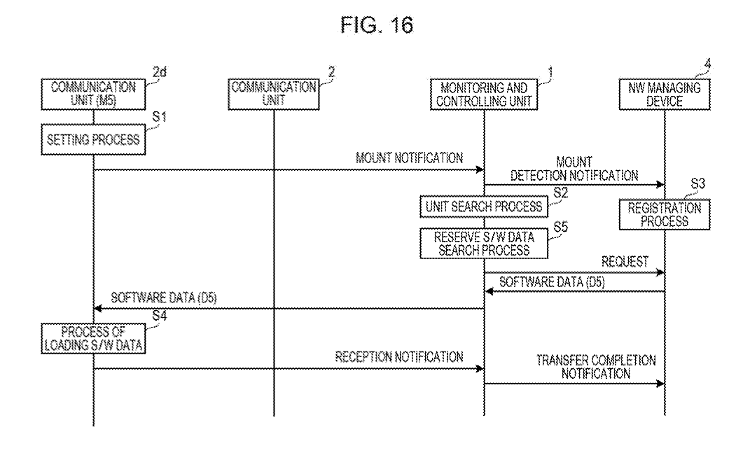

FIG. 16 is a sequence diagram illustrating an example of a process to be executed by the monitoring and controlling system in the case where the software data is transferred by the NW managing device 4 to the new communication unit 2d. In FIG. 16, processes that are common to those illustrated in FIGS. 11 and 14 are indicated by the same reference symbols as those illustrated in FIGS. 11 and 14, and a description thereof is omitted.

When the monitoring and controlling unit 1 has failed to find, from the reserve software data, the software data of the same type as the software data that is used for the new communication unit 2d as a result of the search process S5, the monitoring and controlling unit 1 requests the NW managing device 4 to transmit the corresponding software data. The NW managing device 4 transfers the software data with the data ID “D5” to the monitoring and controlling unit 1 in accordance with the request. The monitoring and controlling unit 1 transfers the software data with the data ID “D5” to the new communication unit 2d. After that, processes that are the same as those illustrated in FIG. 11 are executed. In this manner, the software data is transferred from the NW managing device 4 to the new communication unit 2d.

When a new communication unit 2 is added to a virtual shelf 3 to be monitored and controlled after the activation of the monitoring and controlling system, a monitoring and controlling unit 1 uses one of the three transfer processes described with reference to FIGS. 10 to 16 to transfer software data to the new communication unit 2 in the aforementioned manner.

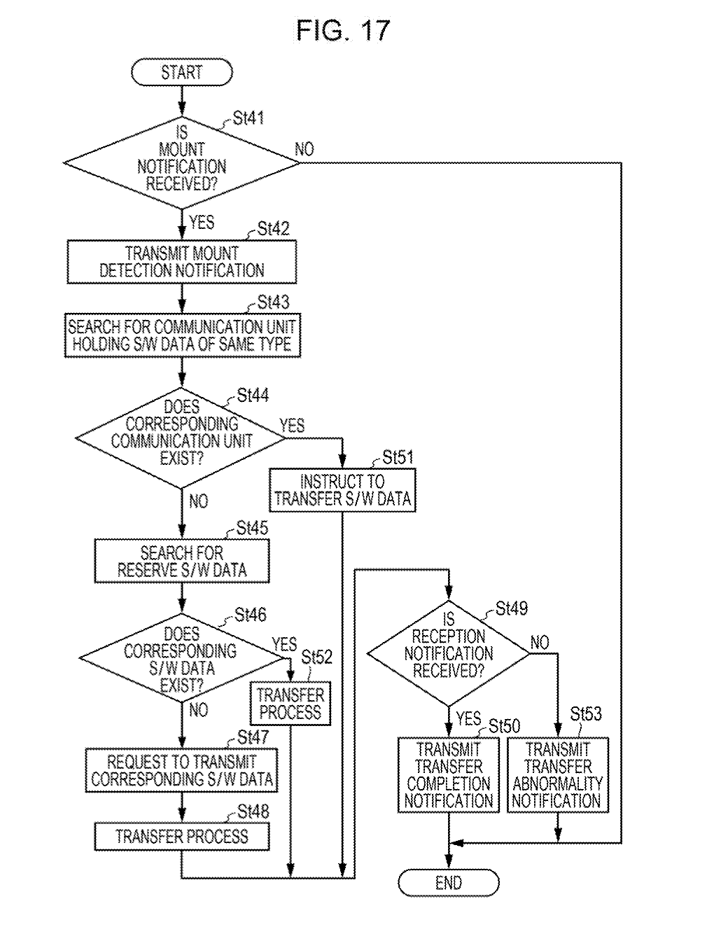

FIG. 17 is an operational flowchart of an example of a process to be executed by each of the monitoring and controlling units 1 after the activation of the monitoring and controlling system. This process is executed at intervals of a certain time period.

First, the controlling unit 100 of the monitoring and controlling unit 1 determines whether or not the monitoring and controlling unit 1 received a mount notification from a new communication unit 2 (in step St41). When the monitoring and controlling unit 1 has not received the mount notification (No in step St41), the controlling unit 100 terminates the process. When the monitoring and controlling unit 1 has received the mount notification (Yes in step St41), the controlling unit 100 transmits a mount detection notification to the NW managing device 4 (in step St42).

Then, the unit searching unit 102 searches the data management TBL 141 for an communication unit 2 holding software data of the same type as software data that is used for the new communication unit 2 (in step St43). When the corresponding communication unit 2 exists (Yes in step St44), the controlling unit 100 instructs the corresponding communication unit 2 to transfer the software data (in step St51). After that, processes of step St49 and later are executed.

When the corresponding communication unit 2 does not exist (No in step St44), the controlling unit 100 searches the storage regions Y1 and Y2 of the nonvolatile memory 13 for the reserve software data of the same type as the software data that is used for the new communication unit 2 (in step St45). When the corresponding reserve software data exists (Yes in step St46), the data transfer processing unit 101 transfers the reserve software data to the new communication unit 2 (in step St52). After that, the processes of step St49 and later are executed.

When the corresponding reserve software data does not exist (No in step St46), the data transfer processing unit 101 requests the NW managing device 4 to transfer the corresponding software data (in step St47). Then, the data transfer processing unit 101 transfers, to the new communication unit 2, the software data transferred from the NW managing device 4 (in step St48).

Next, the controlling unit 100 determines whether or not the monitoring and controlling unit 1 has received, from the communication unit 2, a reception notification indicating that the communication unit 2 received the software data (in step St49). When the monitoring and controlling unit 1 has received the reception notification (Yes in step St49), the controlling unit 100 transmits a transfer completion notification to the NW managing device 4 (in step St50) and terminates the process. When the monitoring and controlling unit 1 has failed to receive the reception notification (No in step St49), the controlling unit 100 transmits a transfer abnormality notification to the NW managing device 4 (in step St53) and terminates the process. In this manner, the monitoring and controlling unit 1 executes the process.

When a monitoring and controlling unit 1 downloads software data to a communication unit 2, the monitoring and controlling unit 1 selects appropriate one of the process for the transfer between communication units 2, the process for the transfer from the monitoring and controlling unit 1, and the process for the transfer from the NW managing device 4.

As described above, each of the monitoring and controlling units 1 is the example of the monitoring and controlling device according to the embodiment, and includes the DL management memory 14, the unit searching unit 102, and the controlling unit 100. The DL management memory 14 stores types of software data held in communication units 2 to be managed and controlled.

When a new communication unit 2 is added to communication units 2 to be monitored and controlled, the unit searching unit 102 searches the DL management memory 14 for a communication unit 2 that is among the communication units 2 to be monitored and controlled and holds software data of the same type as software data that is used for the new communication unit 2. The controlling unit 100 instructs the communication unit 2 searched for by the unit searching unit 102, to transfer the software data to the new communication unit 2.

According to the aforementioned configuration, the controlling unit 100 instructs a communication unit 2 holding software data of the same type as software data that is used for a new communication unit 2 to transfer the software data to the new communication unit 2. Thus, the monitoring and controlling unit 1 does not have to hold the software data of all the types corresponding to all the modes M1, M2, and the like of the communication units 2, thereby reducing a capacity needed for storing the software data.

In addition, the monitoring and controlling system according to the embodiment includes the monitoring and controlling units 1 and the communication units 2 to be monitored and controlled. Each of the monitoring and controlling units 1 includes the DL management memory 14, the unit searching unit 102, and the controlling unit 100. The DL management memory 14 stores types of software data held in communication units 2 to be monitored and controlled.

When a new communication unit 2 is added to communication units 2 to be monitored and controlled, the unit searching unit 102 searches the DL management memory 14 for a communication unit 2 that is among the communication units 2 to be monitored and controlled and holds software data of the same type as data that is used for the new communication unit 2. The controlling unit 100 instructs the communication unit 2 searched for by the unit searching unit 102, to transfer the software data to the new communication unit 2.

The communication unit 2 searched for by the unit searching unit 102 transfers the software data held in the communication unit 2 to the new communication unit 2 in accordance with the instruction from the controlling unit 100. The new communication unit 2 holds the software data transferred from the communication unit 2 searched for by the unit searching unit 102.

Since the monitoring and controlling system according to the embodiment includes the same configurations as the aforementioned monitoring and controlling units 1, the monitoring and controlling system according to the embodiment exhibits the same effects as those described above.

The aforementioned embodiment is a preferred embodiment and is not limited to the above description and may include various modifications and changes without departing from the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus comprising:
a memory configured to store first information in which a type of data held in each of a plurality of communication devices to be monitored and controlled is stored in association with the each communication device;
a processor coupled to the memory and configured to:
when a first communication device that uses data of a first type is added to the plurality of communication devices, search the first information for a second communication device that holds data whose type is the first type, and
instruct the second communication device to transfer data held by the second communication device to the first communication device.

2. The apparatus of claim 1, wherein
the processor is further configured to:
transfer data to the plurality of communication devices,
acquire second information on types of data transferred, and
select and hold first data whose type satisfies a predetermined requirement, based on the second information; and
in a case where the first communication device is added to the plurality of communication devices, the processor transfers the first data to the first communication device when the second communication device is not found from the first information, and the first type matches a type of the first data.

3. The apparatus of claim 2, wherein
the processor acquires third information that stores, in association with each of types of data, a first value indicating a number of communication devices that hold data whose type is identical to the each type of data; and
the processor selects second data in accordance with order of the first value that is stored in association with the first data in the third information, and holds the selected second data.

4. The apparatus of claim 2, wherein
the processor acquires third information that stores, in association with each of types of data, a first value indicating a frequency at which data of the each type is transferred; and
the processor selects second data in accordance with order of the first value that is stored in association with the first data in the third information, and holds the selected second data.

5. The apparatus of claim 2, wherein
the processor acquires third information that stores, in association with each of types of data, a first value indicating a size of data of the each type; and
the processor selects second data in accordance with order of the first value that is stored in association with the first data in the third information, and holds the selected second data.

6. The apparatus of claim 2, wherein
in a case where the first communication device is added to the plurality of communication devices, the processor acquires, from another apparatus, the first data, and transfers the acquired first data to the first communication device when the second communication device is not found from the first information, and the first type of data used for the first communication device does not match a type of the first data.

7. A system comprising:
a monitoring and controlling device including a first processor; and
communication devices to be monitored and controlled by the monitoring and controlling device, each of the communication devices including a second processor, wherein
the monitoring and controlling device further includes a memory configured to store first information in which a type of data held in each of a plurality of communication devices to be monitored and controlled is stored in association with the each communication device;
the first processor of the monitoring and controlling device is configured to:
when a first communication device that uses data of a first type is added to the plurality of communication devices, search the first information for a second communication device that holds data whose type is the first type, and
instruct the second communication device to transfer data held by the second communication device to the first communication device; and
the second processor of the second communication device is configured to, in accordance with instruction of the first processor, transfer data held by the second communication device to the first communication device; and
the second processor of the first communication device is configured to hold data transferred from the first communication device.

8. The system of claim 7, wherein
the first processor is further configured to:
transfer data to the plurality of communication devices,
acquire second information on types of data transferred, and
select and hold first data whose type satisfies a predetermined requirement, based on the second information; and
in a case where the first communication device is added to the plurality of communication devices, the first processor transfers the first data to the first communication device when the second communication device is not found from the first information, and the first type matches a type of the first data.

9. The system of claim 8, wherein
the first processor acquires third information that stores, in association with each of types of data, a first value indicating a number of communication devices that hold data whose type is identical to the each type of data; and
the first processor selects second data in accordance with order of the first value that is stored in association with the first data in the third information, and holds the selected second data.

10. The system of claim 8, wherein
the first processor acquires third information that stores, in association with each of types of data, a first value indicating a frequency at which data of the each type is transferred; and
the first processor selects second data in accordance with order of the first value that is stored in association with the first data in the third information, and holds the selected second data.

11. The system of claim 8, wherein
the first processor acquires third information that stores, in association with each of types of data, a first value indicating a size of data of the each type; and
the first processor selects second data in accordance with order of the first value that is stored in association with the first data in the third information, and holds the selected second data.

12. The system of claim 8, wherein
in a case where the first communication device is added to the plurality of communication devices, the first processor acquires, from another apparatus, the first data, and transfers the acquired first data to the first communication device when the second communication device is not found from the first information, and the first type of data used for the first communication device does not match a type of the first data.
